(19) United States
(12) Patent Application Publication
(10) Pub. No.: US 2026/0220847 A1
(43) Pub. Date: Jul. 30, 2026

(54) HAIR PROCESSING METHOD AND APPARATUS, DEVICE AND STORAGE MEDIUM

(71) Applicant: Beijing Zitiao Network Technology Co., Ltd., Beijing (CN)

(72) Inventors: Jingye WANG, Beijing (CN); Xiaoqi LI, Beijing (CN)

(21) Appl. No.: 19/142,119

(22) PCT Filed: Dec. 6, 2023
(86) PCT No.: PCT/CN2023/136828

§ 371 Date: Jun. 20, 2025

(30) Foreign Application Priority Data
Dec. 22, 2022 (CN) 202211658082.X

(51) Int. Cl. G06T 11/60; G06T 7/73

(52) U.S. Cl. CPC G06T 11/60; G06T 7/73; G06T 2207/10004; G06T 2207/30196

(57) ABSTRACT

The embodiments of the present disclosure relate to a hair processing method and apparatus, a device and a storage medium. The method includes: in response to a scenario feature detection of a current image frame, obtaining an acting force which affects a movement of the hair; obtaining historical particle information of a plurality of hair particles of the hair in a previous image frame, and determining, based on the acting force and the historical particle information, a current particle position of a hair particle in the current image frame; and displaying the hair based on the current particle position of the hair particle in the current image frame.

### CROSS-REFERENCE TO RELATED APPLICATION(S)

The present disclosure claims the priority from the CN patent application No. 202211658082.X entitled “HAIR PROCESSING METHOD AND APPARATUS, DEVICE AND STORAGE MEDIUM” filed Dec. 22, 2022, the content of which is hereby incorporated by reference in its entirety.

### FIELD

The present disclosure generally relates to the field of computers, in particular, a hair processing method and apparatus, a device and a storage medium.

### BACKGROUND

With the development of computer technology, the hair processing technology is often used in scenarios of taking selfies, producing games or movies, or the like, to determine the display position of hairs in each image frame and display the hairs based on the display position of the hairs.

However, when the existing hair processing technology is used to display hairs, there often arises the problem that the display effect of the hairs is not consistent with the scenario features in the image frame, resulting in a poor overall display effect of the image frame.

### SUMMARY

In order to solve, or at least partly solve, the above technical problem, embodiments of the present disclosure provide a hair processing method and apparatus, a device and a storage medium.

In the first aspect of the embodiments of the present disclosure, there is provided a hair processing method, comprising:
in response to a scenario feature detection of a current image frame, obtaining an acting force which affects a movement of a hair;
obtaining historical particle information of a plurality of hair particles of the hair in a previous image frame, and determining, based on the acting force and the historical particle information, a current particle position of a hair particle in the current image frame; and
displaying the hair based on the current particle position of the hair particle in the current image frame.

In a second aspect of the embodiments of the present disclosure, there is provided a hair processing apparatus, comprising:
a first obtaining module configured to obtain an acting force which affects a movement of a hair in response to a scenario feature detection of a current image frame;
a second obtaining module configured to obtain historical particle information of a plurality of hair particles of the hair in a previous image frame, and determine, based on the acting force and the historical particle information, a current particle position of a hair particle in the current image frame; and
a display module configured to display the hair based on the current particle position of the hair particle in the current image frame.

In a third aspect of the embodiments of the present disclosure, there is provided an electronic device, comprising:
a processor and a memory, wherein the memory stores a computer program thereon which, when executed by the processor, performs the method of the first aspect.

In a fourth aspect of the embodiments of the present disclosure, there is provided a computer readable storage medium storing a computer program thereon, wherein the computer program, when executed by a processor, implements the method of the first aspect.

The technical solution provided by the embodiments of the present disclosure has the following advantages over the prior art:

The embodiments of the present disclosure include: in response to a scenario feature detection of a current image frame, obtaining an acting force which affects a movement of a hair; obtaining historical particle information of a plurality of hair particles of the hair in a previous image frame, and determining, based on the acting force and the historical particle information, a current particle position of a hair particle in the current image frame; and displaying the hair based on the current particle position of the hair particle in the current image frame. by implementing the aforementioned technical solution, in response to a scenario feature detection of a current image frame, an acting force which affects a movement of the hair can be obtained, and current particle positions of a plurality of hair particles of the hair in the current image frame can be determined based on the acting force that affects the movement of the hair (i.e., the factor of the acting force that affects the movement of the hair can be taken into account when the current particle positions are determined), such that the effect of displaying the hair based on the current particle positions can match the scenario features of the current image frame, and thus improving the overall display effect of the current image frame.

### BRIEF DESCRIPTION OF THE DRAWINGS

The accompanying drawings, which are incorporated into the Description and formulate a part thereof, show embodiments in line with the present disclosure and explain, together with the Description, the principle of the present disclosure.

In order to illustrate a clearer technical solution according to the embodiments of the present disclosure or the prior art, brief introduction of the drawings required in the embodiments or the prior art will be provided below. Apparently, the person skilled in the art could derive other drawings on the basis of these drawings, without doing creative work.

FIG. 1 illustrates a flowchart of a hair processing method provided by embodiments of the present disclosure;

FIG. 2 illustrates a schematic diagram of a hair structure provided by embodiments of the present disclosure;

FIG. 3 illustrates a schematic diagram of a previous image frame provided by embodiments of the present disclosure;

FIG. 4 illustrates a schematic diagram of a current image frame provided by embodiments of the present disclosure;

FIG. 5 illustrates a flowchart of another hair processing method provided by embodiments of the present disclosure;

FIG. 6 illustrates a logic diagram of adjusting a current particle position provided by embodiments of the present disclosure;

FIG. 7 illustrates another logic diagram of adjusting a current particle position provided by embodiments of the present disclosure;

FIG. 8 illustrates a schematic diagram of a structure of a video processing apparatus provided by embodiments of the present disclosure; and

FIG. 9 illustrates a schematic diagram of a structure of an electronic device provided by embodiments of the present disclosure.

### DETAILED DESCRIPTION OF EMBODIMENTS

In order to make the above objective, features and advantages much clearer, description of the solution according to the present disclosure will be further detailed below. It is worth noting that the embodiments of the present disclosure and the features therein could be combined with each other if no conflict is generated.

Although lots of details will be described below for a full understanding of the present disclosure, the present disclosure can be implemented in other ways than the one described herein. Obviously, the embodiments of the present disclosure are only a part of the embodiments of the present disclosure, not all of them.

Through researches, the applicant has found that: in a case that scenario features of an image frame meet the condition of affecting the hair movement, the existing hair processing technology does not take the acting force that affects the hair movement into consideration when computing the display position of the hair in the image frame, which causes an inconsistency between the result of displaying, based on the display position of the hair, the hair and the scenario features in the image frame, resulting in a poor overall display effect of the image frame. To this end, the embodiments of the present disclosure provide a hair processing method and apparatus, a device and a storage medium. Hereinafter, description will be made to the hair processing method.

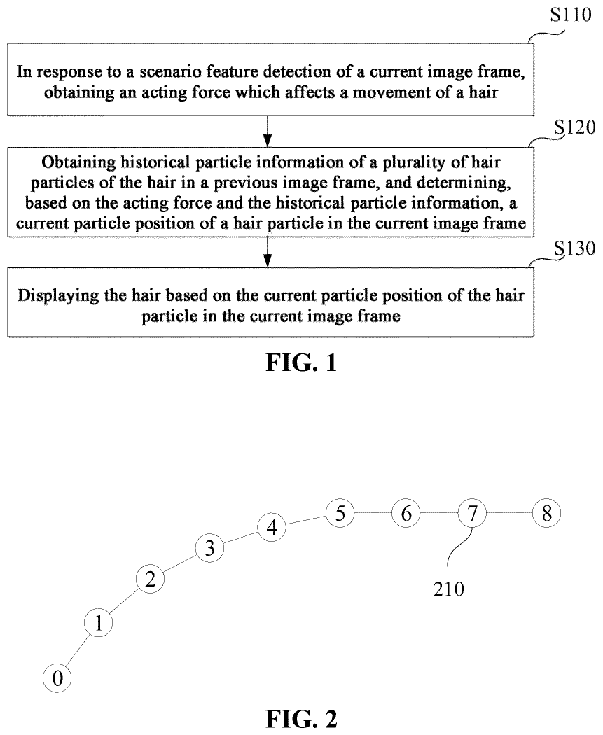

FIG. 1 illustrates a flowchart of a hair processing method provided by embodiments of the present disclosure, which can be performed by an electronic device. The electronic device may be exemplarily understood as a device with a page displaying function such as a mobile phone, a tablet computer, a laptop computer, a desktop computer, a smart TV and the like. As shown, the method provided by the embodiments includes the following steps:

S110: in response to a scenario feature detection of a current image frame, obtaining an acting force which affects a movement of the hair.

In the embodiments of the present disclosure, the hair generation method can be applied to an application scenario where it is required to determine, based on an acting force that affects a movement of hair, current particle positions of a plurality of hair particles of the hair, for example, video creation, image processing and the like. The application scenario may be a two-dimension (2D) application scenario, or may be a 3D application scenario, which is not specifically limited herein. For example, in a scenario where a user takes a selfie with a special-effect hairstyle, the hair generation method may include determining, based on an acting force that affects a movement of hair, current particle positions of a plurality of hair particles of the hair of the special-effect hairstyle, such that the display effect of the special-effect hairstyle matches the scenario features of the current image frame, to thus improve the overall display effect of the current image frame.

Specifically, the hair according to the embodiments of the present disclosure may include at least one type of a hair on the scalp, a hair of a special-effect hairstyle added by the user, or the like, which is not limited thereto. The hair on the scalp can include not only a hair growing on a real person's scalp, but also a hair on a digital human scalp model, and the like, which is not limited thereto. The hair may include a head hair, a body hair, or the like.

In some embodiments, S110 may include: in response to detecting that a head position-posture of a user in the current image frame is changed relative to the previous image frame, obtaining the acting force that affects the movement of the hair.

Specifically, the head position-posture includes a position and a posture of the user's head.

Any possible method can be employed to obtain the head position-posture, and detect whether the head position has been changed, which is not limited specifically herein.

Considering that the hair position and posture are changed when the head position-posture is changed (i.e., when the head is translated or rotated to cause the head position-posture to be changed), it can be employed to obtain the acting force that affects the movement of the hair, when the head position-posture is changed. In the case, the current particle positions of the plurality of hair particles of the hair determined subsequently based on the acting force can match the head position-posture, such that the display effect of the hair can match the scenario features, which is more in line with the pattern of hair moving with the head in the real world.

In some other embodiments, S110 may include: in response to detecting a presence of an external force applied to the hair in the current image frame, obtaining the acting force that affects the movement of the hair.

Specifically, the external force may include at least one of a wind force, gravity, a human force, and the like, which is not limited thereto. The wind power may include a natural wind, a force generated by a wind output by a fan, and the like; the human force is a force applied by the human to hair, for example, a force for combing hair, and the like. However, the wind force and the human force are not limited to the above examples.

Any possible method can be used to detect whether an external force is applied to the hair, which is not limited therein.

Considering that the position and the posture of the hair are changed as an effect of the external force such as a wind force, gravity, a human force, or the like, even though the head position-posture is not changed in the real world, it is employed to obtain an acting force that affects the movement of the hair in response to detecting an external force applied to the hair. In the case, the current particle positions of the plurality of hair particles of the hair determined subsequently based on the acting force can match the acting force, such that the display effect of the hair can match the scenario features, which is more in line with the pattern of hair moving with the wind force, the gravity or the human power in the real world.

S120: obtaining historical particle information of a plurality of hair particles of the hair in a previous image frame, and determining, based on the acting force and the historical particle information, a current particle position of a hair particle in the current image frame.

Specifically, each hair can be regarded as a plurality of segments connected in sequence, where endpoints of the segments are the hair particles. When the particle positions of the hair particles are changed, the position and the shape of the hair are changed accordingly.

By way of example, FIG. 2 is a schematic diagram of a hair structure provided by an embodiment of the present disclosure. As shown, the hair is provided thereon nine hair particles 210, where the nine hair particles 210 are numbered sequentially as 0, 1, 2, 3, 4, 5, 6, 7, and 8 from the hair root to the hair tip. When a particle position of any of the nine hair particles 210 is changed, the position and the shape of the hair are changed accordingly.

Specifically, the historical particle information is particle information of the hair particle in the previous image frame.

The particle information may include at least one of a particle speed, a particle acceleration, a particle position, and the like. Wherein, the particle speed is a movement speed of the hair particle; the particle acceleration is a movement acceleration of the hair particle; the particle position is a position of the hair particle, where the specific representation of the particle position may include: a position of the hair particle in a world coordinate system, or a position in a camera (e.g. the camera capturing the current image frame) coordinate system, which is not limited thereto.

Correspondingly, the historical particle information may include at least one of a historical particle speed, a historical particle acceleration, a historical particle position, or the like, which is not limited thereto.

Specifically, the current particle position is a particle position of the hair particle in the current particle frame.

S130: displaying the hair based on the current particle position of the hair particle in the current image frame.

In some embodiments, if the particle position includes the position of the hair particle in the world coordinate system, the current particle position is a position of the hair particle in the current image frame in the world coordinate system. At this time, S130 may include: converting, based on a conversion relationship between the image coordinate system corresponding to the current image frame and the world coordinate system, the current particle position to the position in the image coordinate system corresponding to the current image frame, and displaying the hair based on the positions of the plurality of hair particles in the image coordinate system corresponding to the current image frame.

In some other embodiments, if the particle position includes a position of the hair particle in the camera coordinate system, the current particle position is a position of the hair particle in the camera coordinate system corresponding to the current image frame. At this time, S130 may include: converting, based on a conversion relationship between the image coordinate system corresponding to the current image frame and the camera coordinate system, the current particle position into a position in the image coordinate system corresponding to the current image frame, and displaying the hair based on the positions of the plurality of hair particles in the image coordinate system corresponding to the current image frame.

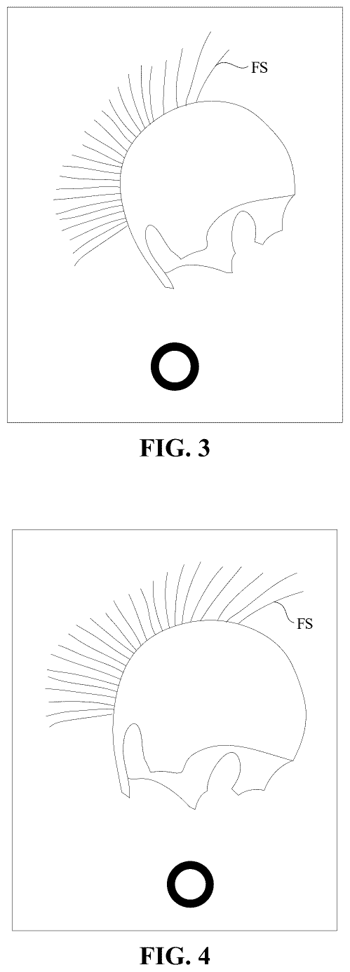

By way of example, FIG. 3 illustrates a schematic diagram of a previous image frame provided by embodiments of the present disclosure. FIG. 4 illustrates a schematic diagram of a current image frame provided by embodiments of the present disclosure. As shown, in a case where a user takes a selfie for a special-effect hairstyle, if the head position-posture is changed in the current image frame as compared with the previous image frame since the user lowered the head, the acting force that affects the movement of the hair can be obtained, historical particle information of the plurality of hair particles of the hair FS in the previous image frame can be obtained, and current particle positions of the plurality of hair particles in the current image frame can be obtained based on the acting force and the historical particle information, such that the hair FS can be displayed based on the current particle positions of the plurality of hair particles in the current image frame, to present the effect that the hair FS with the special-effect hairstyle moves along with the head movement.

The embodiments of the present disclosure include: in response to a scenario feature detection of a current image frame, obtaining an acting force which affects a movement of the hair; obtaining historical particle information of a plurality of hair particles of the hair in a previous image frame, and determining, based on the acting force and the historical particle information, a current particle position of a hair particle in the current image frame; and displaying the hair based on the current particle position of the hair particle in the current image frame. With the aforementioned technical solution, in response to a scenario feature detection of a current image frame, an acting force which affects a movement of the hair can be obtained, and current particle positions of a plurality of hair particles of the hair in the current image frame can be determined based on the acting force that affects the movement of the hair (i.e., the factor of the acting force that affects the movement of the hair is taken into account when the current particle positions are determined), such that the effect of displaying the hair based on the current particle positions can match the scenario features of the current image frame, and thus improving the overall display effect of the current image frame.

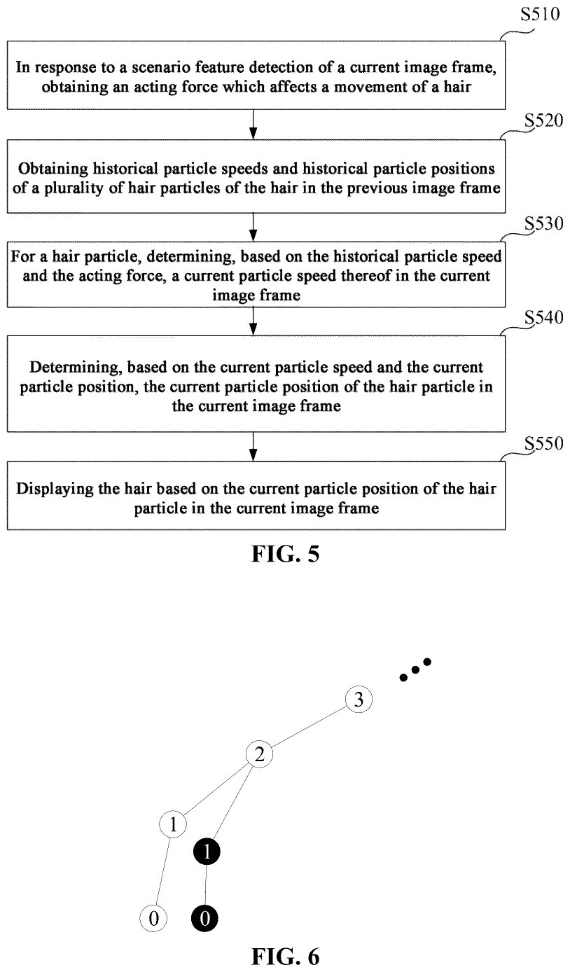

FIG. 5 illustrates a flowchart of another hair processing method provided by embodiments of the present disclosure. The embodiments of the present disclosure relate to an optimization on the basis of the above embodiments, and can be combined with the respective optional solutions according to one or more embodiments described in the foregoing.

As shown, the hair processing method may include the following steps.

S510: in response to a scenario feature detection of a current image frame, obtaining an acting force which affects a movement of a hair.

Specifically, S510 is similar to S110, which will not be detailed herein for brevity.

S520: obtaining historical particle speeds and historical particle positions of a plurality of hair particles of the hair in the previous image frame.

Specifically, S520 is similar to the related part in S120, which will not be detailed herein for brevity.

S530: for any hair particle, determining, based on the historical particle speed and the acting force, a current particle speed thereof in the current image frame.

Specifically, the hair includes a plurality of hair particles each having a historical particle speed. Therefore, for each hair particle, the current particle speed thereof in the current image frame can be determined based on the historical particle speed and the acting force thereof. In this way, a current particle speed of each hair particle in the current image frame can be obtained.

Optionally, determining, based on the historical particle speed and the acting force, the current particle speed of the hair particle in the current image frame includes:

S531: determining, based on the acting force and a mass matrix of the hair particle, a current particle acceleration of the hair particle in the current image frame.

Specifically, the mass matrix incudes a plurality of matrix elements each for characterizing a mass of a hair particle corresponding thereto.

According to the actual condition, those skilled in the art could set a specific value of each matrix element in the mass matrix, which is not limited herein.

For example, each matrix element in the mass matrix is 1, or some matrix elements in the mass matrix are 0 while some others are 1. For example, for each hair, in the case that the plurality of hair particles of the hair are sequentially numbered in the direction from the hair root to the hair tip, where the first hair particle starting from the hair root is numbered as 0, the matrix elements corresponding to the hair particle No. 0 and the hair particle No. 1 in the mass matrix are 0, and the matrix elements corresponding to the hair particles other than hair particles No. 0 and No. 1 are 1. The present disclosure is not limited to this.

Specifically, for each hair particle, a matrix element corresponding to the hair particle can be obtained from the mass matrix, and the current particle acceleration of the hair particle can be obtained by substituting the acting force and the matrix element corresponding to the hair particle into the following equation: acting force=matrix element corresponding to hair particle×current particle acceleration.

S532: determining the current particle speed of the hair particle based on the historical particle speed, the current particle acceleration and a frame time interval between the previous image frame and the current image frame.

Specifically, for each hair particle, the current particle speed of the hair particle can be obtained by substituting the historical particle speed and the acceleration of the hair particle into the following equation: current particle speed=historical particle speed+acceleration×frame time interval.

It would be appreciated that: by determining, based on the historical particle speed and the acting force, the current particle speed of the hair particle, and determining, based on the historical particle speed, the current particle acceleration and the frame time interval, the current particle speed, it can be achieved that the current particle speed conforms to the natural laws of motion; with the arrangement of the mass matrix, those skilled in the art could adjust flexibly the value of each matrix element in the mass matrix according to the characteristics of the actual movement of the hair generated along with the force, and can further adjust flexibly the current particle speed, to obtain a more accurate current particle speed.

S540: determining, based on the current particle speed and the current particle position, the current particle position of the hair particle in the current image frame.

Specifically, for each hair particle, the current particle position thereof in the current image frame can be determined based on the current particle speed and the historical particle position thereof. In this way, the current particle position of each hair particle in the current image frame can be obtained.

Optionally, the current particle position of the hair particle can be determined based on the historical particle position, the mass matrix of the hair particle, the current particle speed and the frame time interval between the previous image frame and the current image frame.

Specifically, the current particle position of each hair particle can be obtained by substituting the current particle speed and the historical particle position of the hair particle into the following equation: current particle position=historical particle position+current particle speed×frame time interval.

In an example, when the acting force that affects the movement of the hair is gravity, and the respective matrix elements in the mass matrix are all 1, or some matrix elements are 0 while some others are 1, the current particle speed=historical particle speed+matrix element corresponding to hair particle×gravity acceleration×frame time interval; and current particle position=historical particle position+matrix element corresponding to hair particle×current particle speed×frame time interval.

S550: displaying the hair based on the current particle position of the hair particle in the current image frame.

Specifically, S530 is similar to S130, which will not be detailed herein for brevity.

By determining, based on the current particle speed and the acting force, the current particle speed of the hair particle, and determining, based on the current particle speed and the historical particle position, the current particle position of the hair particle, the embodiments of the present disclosure can simplify the method for determining the current particle position, which is advantageous for reducing the computing amount of the hair processing method, and further lowering the performance requirement of the hair processing method on the electronic device, such that the hair processing method can be applied not only to a high-end device, but also to a low-end device such as a mobile terminal, and the like).

In a further implementation of the present disclosure, after determining the current particle position of the hair particle in the current image frame, the method further includes: detecting, based on a current head position of a user's head in the current image frame, and the current particle position of the hair particle, whether there is a collision particle located in the user's head among the plurality of hair particles of the hair; in response to detecting a presence of the collision particle, projecting the collision particle onto a surface of the user's head, so as to obtain a corresponding projection position; and using the projection position as the current particle position of the collision particle.

Specifically, the current head position is a position of the user's head in the current image frame.

If the user's head is seen as a capsule, the current head position may be specifically represented by positions of respective points on the user's head surface in the world coordinate system, or the positions thereof in the camera coordinate system. However, the present disclosure is not limited to this.

Specifically, the collision particle is a hair particle with a current particle position within the user's head.

When the hair particle is located within the capsule corresponding to the user's head, it is indicated that the hair particle is located within the user's head, and thus, the hair particle is the collision particle; when the hair particle is located outside the capsule (including the surface) corresponding to the user's head, it is indicated that the hair particle is located outside the user's head, and thus, hair particle is not the collision particle.

Reference may be made to any possible method of projecting a point onto a curved surface, to project the collision particle to the user's head surface, which is not limited herein.

Considering that the hair will never penetrate into the user's head in practice, the embodiments of the present disclosure can move the current particle position of the collision particle out of the user's head by projecting the collision particle to the user's head surface to obtain a corresponding projection position, and using the projection position as the current particle position of the hair particle, such that all the hair particles are located outside the user's head. In this way, the hair displayed based on the updated current hair particle conforms to the rule of being outside the user's head, such that the display effect of the hair is more in line with the actual situation.

In a further implementation of the present disclosure, after determining the current particle position of the hair particle in the current image frame, the method further includes: obtaining a user head model matrix corresponding to the current image frame, and obtaining initial particle positions pre-configured for the plurality of hair particles of the hair; determining, based on the user head model matrix and the initial particle positions, fixed particle positions of the plurality of hair particles of the hair in the current image frame; and adjusting, based on the fixed particle positions, the current particle positions.

Specifically, the “current particle positions” in “adjusting, based on the fixed particle positions, the current particle positions” may be current particle positions after the step of “determining the current particle position of the hair particle in the current image frame,” or may be current particle positions after the step of “using the projection position as the current particle position of the collision particle,” which is not limited herein.

Specifically, the user head model matrix is used to describe the position of the user's head in the world coordinate system.

Correspondingly, the user head model matrix corresponding to the current image frame is used to describe the position of the user's head in the current image frame in the world coordinate system.

Specifically, the initial particle position is a position of the hair particle in a head model space corresponding to the hairstyle to which it belongs. In other words, a hairstyle is formed by a plurality of hairs, and a position of each hair particle on the plurality of the hairs in the head model space is the initial particle position of the hair particle.

For example, when designing an effect hairstyle, the designer needs to set the initial particle position of each hair particle on a plurality of hairs corresponding to the special-effect hairstyle, such that the plurality of hairs can present the specific hairstyle.

Specifically, the fixed particle position is a position of a hair particle in the world coordinate system when the hair particle remains unchanged relative to the user's head.

Specifically, for each hair particle, the fixed particle position thereof can be obtained by multiplying the initial particle position with the user head model matrix corresponding to the current image.

In some embodiments, adjusting, based on the fixed particle position, the current particle position may include: for each hair particle, using the fixed particle position of the hair particle as the current particle position of the hair particle in the current image frame. In this way, during the movement of the hair, the relative position of the hair can be kept unchanged relative to the user's head, i.e., the hairstyle can be kept unchanged.

In some other embodiments, adjusting, based on the fixed particle position, the current particle position may include; obtaining, from the fixed particle positions of the plurality of hair particles, a first fixed particle position corresponding to a first hair particle sorted from a hair root position of the hair, and a second fixed particle position corresponding to a second hair particle; using the first fixed particle position as a current particle position of the first hair particle in the current image frame; and using the second fixed particle position as a current particle position of the second hair particle in the current image frame.

Specifically, the first fixed particle position is a fixed particle position of the first hair particle sorted from the root position of the hair, and the second fixed particle position is a fixed particle position of the second hair particle sorted from the root position of the hair.

By way of example, FIG. 6 illustrates a logic schematic diagram of adjusting a current particle position provided by embodiments of the present disclosure. For the hair shown therein, the hair particle No. 0 is the first hair particle sorted from the root position of the hair, and the fixed particle position of the hair particle No. 0 is thus the current particle position thereof in the current image frame; the first fixed particle position of the hair particle No. 0 is used as the current particle position thereof in the current image frame, i.e., the current particle position of the hair particle No. 0 is adjusted from the white circle fill position No. 0 to the black circle fill position No. 0. The hair particle No. 1 is the second hair particle sorted from the root position of the hair, and the fixed particle position of the hair particle No. 1 is thus the second fixed particle position; the second fixed particle position of the hair particle No. 1 is used as the current particle position thereof in the current image frame, i.e., the current particle position of the hair particle No. 1 is adjusted from the white circle fill position No. 1 to the black circle fill position No. 1.

Considering that the hair particle close to the hair root position remains unchanged relative to the user's head even though the position-posture of the user's head has changed, or the wind force or external force causes the hair to move, in the embodiments of the present disclosure, the first fixed particle position is used as the current particle position of the first hair particle in the current image frame, the second fixed particle position is used as the current particle position of the second hair particle in the current image frame, and the relative positions of the first hair particle and the second hair particle are kept unchanged relative to the user's head. In this way, the movement of the hair as an effect of the external force is more in line with the actual movement pattern, thus achieving a realistic hair movement effect.

Optionally, the method further includes: adjusting, based on the first fixed particle position and the second fixed particle position, current particle positions of other hair particles of the hair in the current image frame, such that a distance between adjacent hair particles in the other hair particles after adjusting is equal to a distance between the first fixed particle position and the second fixed particle position.

Specifically, the distance between the first fixed particle and the second fixed particle is computed based on the first fixed particle position and the second fixed particle position, as a standard distance; for the j^{th} hair particle sorted from the root position of the hair, the current particle position of the j^{th} hair particle, and the current particle position of the (j-1)^{th} hair particle adjacent to the j^{th} hair particle and the close to the hair root are obtained; a first difference value is obtained by subtracting the current particle position of the (j-1)^{th} hair particle from the current particle position of the j^{th} hair particle; a distance between the j^{th} hair particle and the (j-1)^{th} hair particle is computed based on the current particle position of the j^{th} hair particle and the (j-1)^{th} hair particle, to obtain a first distance; a first ratio is obtained by dividing the first difference by the first distance; a first product is obtained by multiplying the first ratio with the standard distance; the adjusted current particle position of the j^{th} hair particle is obtained by adding the current particle position of the j^{th} hair particle to the first product; wherein, j is an integer greater than 2 while being less than or equal to a total number of hair particles of the hair to which they belong, and the current particle position of the (j-1)^{th} hair particle used herein is a current particle position of the (j-1)^{th} hair particle when the distance between the j^{th} hair particle and the (j-1)^{th} hair particle is equal to the standard distance.

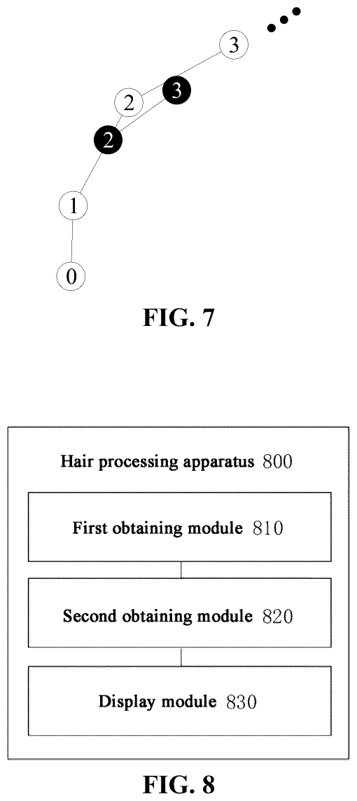

By way of example, FIG. 7 illustrates a further logic schematic diagram of adjusting a current particle position provided by embodiments of the present disclosure. Referring to FIG. 7, the current particle position of the hair particle No. 0 (i.e., the first fixed particle) is its fixed particle position (i.e., the first fixed particle position), and the current particle position of the hair particle No. 1 (i.e., the second fixed particle) is its fixed particle position (i.e., the second fixed particle position). A distance (i.e., a standard distance) between the hair particle No. 0 and the hair particle No. I can be determined between the first fixed particle position and the second fixed particle position, and the current particle position of the hair particle No. 2 is adjusted from the white circle fill position No. 2 to the black circle fill No. 2, based on the standard distance, such that the distance between the hair particle No. 2 and the hair particle No. 1 is a standard distance (i.e., the distance between the white circle fill position No. 2 and the white circle fill position No. 1 is a standard distance); likewise, the current particle position of the hair particle No. 3 is adjusted from the white circular fill position No. 3 to the black circular fill position No. 3, such that the distance between the hair particle No. 3 and the hair particle No. 2 is a standard distance (i.e., the distance between the black circle fill position No. 3 and the black circle fill position No. 2 is a standard distance). For the hair particle following the hair particle No. 3, the logic for adjusting the current particle position thereof is similar to that for adjusting the position of the hair particle No. 3, which will not be detailed for brevity.

It would be appreciated that the current particle positions of other hair pairs in the current image frame are adjusted such that a distance between adjacent hair particles in the other hair particles after adjusting is equal to a distance between the first fixed particle position and the second fixed particle position. In the case, the distances between the hair particles of the hair are the same and appropriate, avoiding generation of broken lines due to a too great distance between the hair particles, and thus making the hair smooth and realistic.

In a further implementation of the present disclosure, after adjusting, based on the fixed particle positions, the current particle positions, the method further includes: obtaining a mixing ratio corresponding to a number of the hair particles of the hair; and continuing to adjust, based on the fixed particle positions and the mixing ratio, the current particle positions.

Specifically, the mixing ratio is a ratio of the hair particles having the current particle positions to be further adjusted based on the fixed particle positions to the plurality of hair particles of the hair.

The specific value of the mixing ratio could be set by those skilled in the art as required, which is not limited herein. For example, the mixing ratio may be valued between 0.3 and 0.4, but is not limited to the range.

Specifically, for each hair, the number of hair particles having the current particle positions to be further adjusted can be obtained by multiplying the total number of the hair particles of the hair with the mixing ratio.

In some embodiments, continuing to adjust, based on the fixed particle positions and the mixing ratio, the current particle positions includes: randomly selecting, from the hair, the hair particles having the current particle positions to be further adjusted, and continuing to adjust the current particle positions of the randomly selected hair particles.

In some embodiments, continuing to adjust, based on the fixed particle positions and the mixing ratio, the current particle positions includes: obtaining, from the fixed particle positions of the hair particles of the hair, a part of the fixed particle positions sorted from a hair root position of the hair according to the mixing ratio; obtaining, from the current particle positions of the plurality of hair particles of the hair, a part of the current particle positions sorted from the hair root position of the hair, wherein a number of the part of the current particle positions is equal to a number of the part of fixed particle positions; obtaining a preset first weight corresponding to the part of fixed particle positions, and a second weight corresponding to the part of the current particle positions; and performing, based on the first weight and the second weight, linear mixing processing on the part of the fixed particle positions and the part of the current particle positions, and adjusting, based on a processing result, the part of the current particle positions.

Specifically, the specific values of the first weight and the second weight could be set by those skilled in the art as actually required, which is not limited herein. For example, the first weight is 0.8, and the second weight is 0.2; however, the values are not limited to these.

By way of example, if the hair includes sixty hair particles, and the mixing ratio is 0.3, it is required to continue to adjust current particle positions of eighteen hair particles. From the fixed particle positions of the hair particles of the hair, the fixed particle positions (i.e., a part of the fixed particle positions) of the hair particles No. 1 through No. 18 sorted from the hair root of the hair; from the current particle positions of the hair particles of the hair, the current particle positions (i.e., a part of the current particle positions) of the hair particles No. 1 through No. 18 sorted from the hair root of the hair are obtained; a preset first weight corresponding the part of the fixed particle positions, and a second weight corresponding to the part of the current particle positions are obtained; for each of the 18 hair particles, the current particle position thereof after the further adjustment can be obtained by adding a product of the fixed particle position thereof and the first weight to a product of the current particle position thereof and the second weight.

By continuing to adjust the current particle position based on the fixed particle position and the mixing ratio, the difference between the current particle position and the fixed particle position can be reduced, i.e., the current particle position is caused to be closer to the fixed particle position. As such, the hair is restricted for the hairstyle such that the hair fits better with the hairstyle, avoiding a too big divergence of the shape of the moved hair from the initial hairstyle.

In a further implementation of the present disclosure, the method further includes: determining a first speed based on the current particle position and the historical particle position of a hair particle, and the frame time interval; determining a second speed based on a current particle position and a historical particle position of another hair particle adjacent to the hair particle and close to a hair tip, and the frame time interval; and obtaining a speed difference between the first speed and the second speed, and updating, with the speed difference, the current particle speed of the hair particle as a historical particle speed for a next frame.

Specifically, for each hair particle, the first speed is obtained by dividing the difference, which is obtained by subtracting the historical particle position from the current particle position of the hair particle, by the frame time interval; the second speed is obtained by dividing the difference, which is obtained by subtracting the historical particle position from the current particle position of the following adjacent hair particle, by the frame time interval, where the following adjacent hair particle is another hair particle adjacent to the hair particle and close to the hair tip; the speed difference is obtained by subtracting the second speed from the first speed, and the current particle speed of the hair particle is updated using the speed difference, as the historical particle speed of the next frame.

In general, the particle speed should be obtained by dividing the difference (i.e., the displacement) between the current particle position and the historical particle position by the time interval. However, for each hair particle on the hair, the following adjacent hair particle of the hair particle impacts the particle speed of the hair particle. Therefore, by updating, using the speed difference, the current particle speed of the hair particle as the historical particle speed of the next frame, the historical particle speed of the next frame is more consistent with the actual speed, to thus obtain a more accurate particle position in the next frame.

FIG. 8 illustrates a schematic diagram of a structure of a hair processing apparatus provided by an embodiment of the present disclosure. The hair processing apparatus may be read as the electronic device described above, or some functional modules therein. As shown, the hair processing apparatus 80 includes:
a first obtaining module 810 configured to obtain an acting force which affects a movement of a hair in response to a scenario feature detection of a current image frame;
a second obtaining module 820 configured to obtain historical particle information of a plurality of hair particles of the hair in a previous image frame, and determine, based on the acting force and the historical particle information, a current particle position of a hair particle in the current image frame; and a display module 830 configured to display the hair based on the current particle position of the hair particle in the current image frame.

In another implementation of the present disclosure, the first obtaining module 810 may include:
a first response sub-module for obtaining the acting force that affects the movement of the hair in response to detecting that a head position-posture of a user in the current image frame is changed relative to the previous image frame; and/or
a second response sub-module for obtaining the acting force that affects the movement of the hair in response to detecting a presence of an external force applied to the hair in the current image frame.

In a further implementation of the present disclosure, the historical particle information comprises: a historical particle speed and a historical particle position; and the second obtaining module 820 may include:
a first determining sub-module for, for a hair particle, determining, based on the historical particle speed and the acting force, a current particle speed of the hair particle in the current image frame; and
a second determining sub-module for determining, based on the current particle speed and the historical particle position, a current particle position of the hair particle in the current image frame.

In a still further implementation of the present disclosure, the first determining sub-module may include:
a first determining unit for determining, based on the acting force and a mass matrix of the hair particle, a current particle acceleration of the hair particle in the current image frame;
a second determining unit for determining the current particle speed of the hair particle based on the historical particle speed, the current particle acceleration and a frame time interval between the previous image frame and the current image frame; and
the second determining sub-module may include:
a third determining unit for determining the current particle position of the hair particle based on the historical particle position, the mass matrix of the hair particle, the current particle speed and the frame time interval.

In a still further implementation of the present disclosure, the apparatus may further include:
a first detection module for detecting, based on a current head position of a user's head in the current image frame, and the current particle position of the hair particle, whether there is a collision particle located in the user's head among the plurality of hair particles of the hair;
a projection module for, in response to detecting a presence of the collision particle, projecting the collision particle onto a surface of the user's head, so as to obtain a corresponding projection position; and
a first determining module for using the projection position as the current particle position of the collision particle.

In a still further implementation of the present disclosure, the apparatus may further include:
a third obtaining module for obtaining a user head model matrix corresponding to the current image frame, and obtaining initial particle positions pre-configured for the plurality of hair particles of the hair;
a second determining module for determining, based on the user head model matrix and the initial particle positions, fixed particle positions of the plurality of hair particles of the hair in the current image frame; and a first adjustment module for adjusting, based on the fixed particle positions, the current particle positions.

In a still further implementation of the present disclosure, the first adjustment module may include:
a second obtaining sub-module for obtaining, from the fixed particle positions of the plurality of hair particles, a first fixed particle position corresponding to a first hair particle sorted from a hair root position of the hair, and a second fixed particle position corresponding to a second hair particle;
a third determining sub-module for using the first fixed particle position as a current particle position of the first hair particle in the current image frame; and
a fourth determining sub-module for using the second fixed particle position as a current particle position of the second hair particle in the current image frame.

In still a further implementation of the present disclosure, the apparatus may further include:
a second adjustment module for adjusting, based on the first fixed particle position and the second fixed particle position, current particle positions of other hair particles of the hair in the current image frame, such that a distance between adjacent hair particles in the other hair particles after adjusting is equal to a distance between the first fixed particle position and the second fixed particle position.

In a still further implementation of the present disclosure, the apparatus may further include:
a fourth obtaining module for obtaining a mixing ratio corresponding to a number of the plurality of hair particles of the hair; and
a third adjustment module for continuing to adjust, based on the fixed particle positions and the mixing ratio, the current particle positions.

In a still further implementation of the present disclosure, the third adjustment module may include:
a second obtaining sub-module for obtaining, from the fixed particle positions of the plurality of hair particles of the hair, a part of the fixed particle positions sorted from a hair root position of the hair according to a third obtaining sub-module for obtaining, from the current particle positions of the plurality of hair particles of the hair, a part of the current particle positions sorted from the hair root position of the hair, wherein a number of the part of the current particle positions is equal to a number of the part of fixed particle positions;

a fourth obtaining sub-module for obtaining a preset first weight corresponding to the part of fixed particle positions, and a second weight corresponding to the part of the current particle positions; and an adjustment sub-module for performing, based on the first weight and the second weight, linear mixing processing on the part of the fixed particle positions and the part of the current particle positions, and adjusting, based on a processing result, the part of the current particle positions.

In a still further implementation of the present disclosure, the apparatus further includes:
a third determining module for determining a first speed based on the current particle position and the historical particle position of a hair particle, and the frame time interval;
a fourth determining module for determining a second speed based on a current particle position and a historical particle position of another hair particle adjacent to the hair particle and close to a hair tip, and the frame time interval; and
a fifth obtaining module for obtaining a speed difference between the first speed and the second speed, and updating, with the speed difference, the current particle speed of the hair particle as a historical particle speed for a next frame.

The apparatus provided by the embodiment can perform the method according to any of the embodiments described above, and the execution and the advantageous effects thereof are similar to those described above, which will not be detailed herein for brevity.

In addition to the method and the apparatus, the embodiments of the present disclosure further provide a computer readable storage medium having instructions stored therein, where the instructions, when running a terminal device, cause the terminal device to implement the method according to any of the embodiments described above.

The embodiments of the present disclosure further provide an electronic device. The electronic device includes: a memory having a computer program stored thereon; and a processor configured to execute the computer program which, when executed by the processor, performs the method according to any of the embodiments described above.

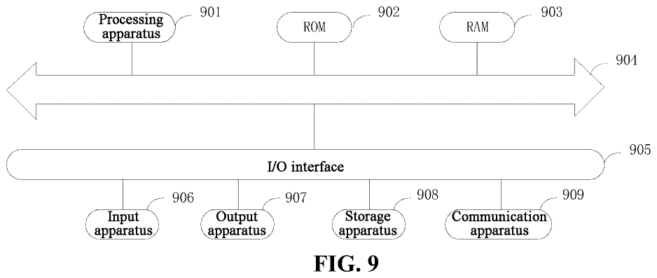

By way of example, FIG. 9 illustrates a schematic diagram of an electronic device according to an embodiment of the present disclosure. Specifically, FIG. 9 shows an electronic device 900 adapted to implement the embodiments of the present disclosure. The electronic device 900 according to the embodiment of the present disclosure may include, but is not limited to, a mobile terminal such as a mobile phone, a laptop computer, a digital broadcast receiver, a Personal Digital Assistant (PDA), a tablet computer (PAD), a Portable Multimedia Player (PMP), an on-vehicle terminal (e.g. an on-vehicle navigation terminal) or the like, or a fixed terminal such as a digital TV, a desktop computer or the like. The electronic device as shown in FIG. 9 is only an example, without suggesting any limitation to the functions and the application range of the embodiments of the present disclosure.

As shown, the electronic device 900 may include a processing (e.g. a central processor, a graphics processor or the like) 901, which can execute various acts and processing based on programs stored in a Read-Only Memory (ROM) 902 or a program loaded from a storage apparatus 908 to a Random-Access Memory (RAM) 903. RAM 903 stores therein various programs and data required for operations of the electronic device 900. The processing apparatus 901, the ROM 902 and the RAM 903 are connected to one another via a bus 904. An input/output (I/O) interface 905 is also connected to the bus 904.

Typically, the following units may be connected to the I/O interface 905: an input apparatus 906 including, for example, a touchscreen, a touch pad, a keyboard, a mouse, a camera, a microphone, an accelerometer, a gyroscope and the like; an output apparatus 907 including, for example, a Liquid Crystal Display (LCD), a loudspeaker, a vibrator and the like; a storage apparatus 908 including, for example, a tape, a hard drive and the like; and a communication apparatus 909. The communication apparatus 909 can allow wireless or wired communication of the electronic device 900 with other devices to exchange data. Although FIG. 9 shows the electronic device 900 including various units, it would be appreciated that not all of the units as shown are required to be implemented or provided. Alternatively, more or fewer units may be implemented or provided.

According to embodiments of the present disclosure, the processes described above with reference to the flowcharts may be implemented as computer software programs. For example, embodiments of the present disclosure include a computer program product comprising computer programs carried on a computer readable medium, where the computer programs containing program code are used for performing the methods as in the flowcharts. In those embodiments, the computer programs may be downloaded and installed from a network via the communication apparatus 909, or may be installed from the storage apparatus 908, or may be installed from the ROM 902. The computer programs, when executed by the processing apparatus 901, perform the above-described functions defined in the method according to the embodiments of the present disclosure.

It should be noted that the computer readable medium according to the present disclosure may be a computer readable signal medium or a computer readable storage medium or any combination of the two. The computer readable storage medium may be, for example, but not limited to, an electronic, magnetic, optical, electromagnetic, infrared, or semiconductor system, apparatus, or device, or any combination of the foregoing. More specific examples of the computer readable storage medium may include, but are not limited to: an electrical connection having one or more wires, a portable computer diskette, a hard disk, a Random Access Memory (RAM), a Random-Only Memory (ROM), an Erasable Programmable Read-Only Memory (EPROM or flash memory), an optical fiber, a portable Compact Disc Read-Only Memory (CD-ROM), an optical storage apparatus, a magnetic storage device, or any suitable combination of the foregoing. In the present disclosure, a computer readable storage medium may be any tangible medium that can contain, or store, a program for use by or in connection with an instruction execution system, apparatus, or device. In contrast, in the present disclosure, a computer readable signal medium may include a propagated data signal with computer readable program code embodied therein, either in baseband or as part of a carrier wave. Such propagated data signal may take many forms, including, but not limited to, an electro-magnetic signal, an optical signal, or any suitable combination thereof. A computer readable signal medium may also be any computer readable medium that is not a computer readable storage medium and that can communicate, propagate, or transmit a program for use by or in connection with an instruction execution system, apparatus, or device. Program code embodied on a computer readable medium may be transmitted using any appropriate medium, including but not limited to: electrical wires, optical cables, RF (radio frequency), etc., or any suitable combination of the foregoing.

In some embodiments, the client and the server may perform communication by using any known network protocol such as Hyper Text Transfer Protocol (HTTP) or any network protocol to be developed, and may connect with digital data in any form or carried in any medium (for example, a communication network). The communication network includes a Local Area Network (LAN), a Wide Area Network (WAN), an international network (for example, the internet), a peer-to-peer network (e.g. ad hoc peer-to-peer network), and any known network or network to be developed.

The computer-readable medium may be the one included in the electronic device, or may be provided separately, rather than assembled in the electronic device.

The computer-readable medium carries one or more programs which, when executed by the electronic device, cause the electronic device to:
in response to a scenario feature detection of a current image frame, obtain an acting force which affects a movement of the hair;
obtain historical particle information of a plurality of hair particles of the hair in a previous image frame, and determine, based on the acting force and the historical particle information, a current particle position of a hair particle in the current image frame; and
display the hair based on the current particle position of the hair particle in the current image frame.

Computer program code for performing operations of the present disclosure may be written by using one or more program design language or any combination. The program design language includes, but is not limited to, object oriented program design language such as Java, Smalltalk and C++, and further includes conventional process-type program design language such as “C” or similar program design language. The program code may be completely or partially executed on a user computer, performed as an independent software packet, partially executed on the user computer and partially executed on a remote computer, or completely executed on the remote computer or a server. In a case of involving the remote computer, the remote computer may connect to the user computer via any type of network such as a Local Area Network (LAN) and a Wide Area Network (WAN). Alternatively, the remote computer may connect to an external computer (such as achieving internet connection by services provided by the internet network service provider).

The flowchart and block diagrams in the drawings illustrate the architecture, functionality and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowcharts, and combinations of blocks in the block diagrams and/or flowcharts, can be implemented by special purpose hardware-based systems which perform the specified functions or acts, or combinations of special purpose hardware and computer instructions.

Related units for describing the embodiments of the present disclosure may be implemented in the form of software, or may be implemented in the form of hardware. In certain circumstances, the names of units/modules do not formulate limitation to the units per se.

The functions described above may be performed, at least in part, by one or more hardware logic components. For example, without limitation, exemplary types of hardware logic components that may be used include: Field Programmable Gate Arrays (FPGAs), Application Specific Integrated Circuits (ASICs), Application Specific Standard Products (ASSPs), Systems on Chip (SOCs), Complex Programmable Logic Devices (CPLDs), and the like.

In the context of this disclosure, a machine-readable medium may be a tangible medium that can contain or store a program for use by or in connection with an instruction execution system, apparatus, or device. The machine-readable medium may be a machine-readable signal medium or a machine-readable storage medium. A machine-readable medium may include, but is not limited to, an electronic, magnetic, optical, electromagnetic, infrared, or semiconductor system, apparatus, or device, or any suitable combination of the foregoing. More specific examples of a computer-readable storage medium would include an electrical connection based on one or more wires, a portable computer diskette, a hard disk, a RAM, an ROM, an EPROM or flash memory, an optical fiber, a CD-ROM, an optical storage device, a magnetic storage device, or any suitable combination of the foregoing.

The embodiments of the present disclosure further provide a computer readable storage medium having a computer program stored thereon, where the computer program, when executed by a processor, implements the method according to any of the embodiments described above. The execution and the advantageous effects hereof are similar to those described above, which are not detailed herein for brevity.

The relationship terms as used herein, for example, “first”, “second”, and the like, are only intended for distinguishing an entity or operation from a further entity or operation, but not necessarily require or imply that those entities or operations should have any of such actual relationships or orders. In addition, the terms “include”, “comprise”, or any other variant thereof are intended to cover a non-exclusive inclusion, such that a process, method, article, or device including a series of elements not only include those elements, but also cover other elements not listed explicitly, or further cover inherent elements of the process, method, article, or device. Unless specified otherwise, elements defined by the expression “including one . . . ” do not exclude presence of additional identical elements in the process, method, article, or device including those elements.

The previous description of the disclosed embodiments is provided to enable those skilled in the art to implement or apply the present disclosure. Various modifications to these embodiments will be readily apparent to those skilled in the art, and the generic principles defined herein may be applied to other embodiments without departing from the spirit or scope of the present disclosure. Thus, the present disclosure is not intended to be limited to the embodiments shown herein but is to be accorded the widest scope consistent with the principles and novel features disclosed herein.

1. A hair processing method, comprising:
in response to a scenario feature detection of a current image frame, obtaining an acting force which affects a movement of a hair;
obtaining historical particle information of a plurality of hair particles of the hair in a previous image frame, and determining, based on the acting force and the historical particle information, a current particle position of a hair particle in the current image frame; and
displaying the hair based on the current particle position of the hair particle in the current image frame.

2. The method of claim 1, wherein in response to the scenario feature detection of the current image frame, obtaining the acting force which affects the movement of the hair comprises:
in response to at least one of detecting that a head position-posture of a user in the current image frame is changed relative to the previous image frame, and/or detecting a presence of an external force applied to the hair in the current image frame, obtaining the acting force which affects the movement of the hair.

3. The method of claim 1, wherein the historical particle information comprises: a historical particle speed and a historical particle position;
and wherein determining, based on the acting force and the historical particle information, the current particle positions of the hair particle in the current image frame comprises:
for a hair particle, determining, based on the historical particle speed and the acting force, a current particle speed of the hair particle in the current image frame; and
determining, based on the current particle speed and the historical particle position, a current particle position of the hair particle in the current image frame.

4. The method of claim 3, wherein determining, based on the historical particle speed and the acting force, the current particle speed of the hair particle in the current image frame comprises:
determining, based on the acting force and a mass matrix of the hair particle, a current particle acceleration of the hair particle in the current image frame; and
determining the current particle speed of the hair particle based on the historical particle speed, the current particle acceleration and a frame time interval between the previous image frame and the current image frame;
and wherein determining, based on the current particle speed and the historical particle position, the current particle position of the hair particle comprises:
determining the current particle position of the hair particle based on the historical particle position, the mass matrix of the hair particle, the current particle speed and the frame time interval.

5. The method of claim 1, wherein after determining the current particle position of the hair particle in the current image frame, the method further comprises:
detecting, based on a current head position of a user's head in the current image frame, and the current particle position of the hair particle, whether there is a collision particle located in the user's head among the plurality of hair particles of the hair;
in response to detecting a presence of the collision particle, projecting the collision particle onto a surface of the user's head, so as to obtain a corresponding projection position; and
using the projection position as the current particle position of the collision particle.

6. The method of claim 1, wherein after determining the current particle position of the hair particle in the current image frame, the method further comprises:
obtaining a user head model matrix corresponding to the current image frame, and obtaining initial particle positions pre-configured for the plurality of hair particles of the hair;
determining, based on the user head model matrix and the initial particle positions, fixed particle positions of the plurality of hair particles of the hair in the current image frame; and
adjusting, based on the fixed particle positions, the current particle positions.

7. The method of claim 6, wherein adjusting, based on the fixed particle positions, the current particle positions comprises:
obtaining, from the fixed particle positions of the plurality of hair particles, a first fixed particle position corresponding to a first hair particle sorted from a hair root position of the hair, and a second fixed particle position corresponding to a second hair particle;
using the first fixed particle position as a current particle position of the first hair particle in the current image frame; and
using the second fixed particle position as a current particle position of the second hair particle in the current image frame.

8. The method of claim 7, further comprising:
adjusting, based on the first fixed particle position and the second fixed particle position, current particle positions of other hair particles of the hair in the current image frame, such that a distance between adjacent hair particles in the other hair particles after adjusting is equal to a distance between the first fixed particle position and the second fixed particle position.

9. The method of claim 6, wherein after adjusting, based on the fixed particle positions, the current particle positions, the method further comprises:
obtaining a mixing ratio corresponding to a number of the plurality of hair particles of the hair; and
continuing to adjust, based on the fixed particle positions and the mixing ratio, the current particle positions.

10. The method of claim 9, wherein continuing to adjust, based on the fixed particle positions and the mixing ratio, the current particle positions comprises:
obtaining, from the fixed particle positions of the plurality of hair particles of the hair, a part of the fixed particle positions sorted from a hair root position of the hair according to the mixing ratio;
obtaining, from the current particle positions of the plurality of hair particles of the hair, a part of the current particle positions sorted from the hair root position of the hair, wherein a number of the part of the current particle positions is equal to a number of the part of fixed particle positions;
obtaining a preset first weight corresponding to the part of fixed particle positions, and a second weight corresponding to the part of the current particle positions; and
performing, based on the first weight and the second weight, linear mixing processing on the part of the fixed particle positions and the part of the current particle positions, and adjusting, based on a processing result, the part of the current particle positions.

11. The method of claim 1, further comprising:
determining a first speed based on the current particle position and the historical particle position of a hair particle, and the frame time interval;
determining a second speed based on a current particle position and a historical particle position of another hair particle adjacent to the hair particle and close to a hair tip, and the frame time interval; and
obtaining a speed difference between the first speed and the second speed, and updating, with the speed difference, the current particle speed of the hair particle as a historical particle speed for a next frame.

12. (canceled)

13. An electronic device, comprising:
a processor; and
a memory, wherein the memory stores computer instructions thereon which, when executed by the processor, cause the electronic device to:
in response to a scenario feature detection of a current image frame, obtain an acting force which affects a movement of a hair;
obtain historical particle information of a plurality of hair particles of the hair in a previous image frame, and determine, based on the acting force and the historical particle information, a current particle position of a hair particle in the current image frame; and
display the hair based on the current particle position of the hair particle in the current image frame.

14. A non-transitory computer readable storage medium storing a computer program thereon, wherein the computer program, when executed by a processor, cause the processor to:
in response to a scenario feature detection of a current image frame, obtain an acting force which affects a movement of a hair;
obtain historical particle information of a plurality of hair particles of the hair in a previous image frame, and determine, based on the acting force and the historical particle information, a current particle position of a hair particle in the current image frame; and
display the hair based on the current particle position of the hair particle in the current image frame.

15. (canceled)

16. The electronic device of claim 13, wherein the instructions to in response to the scenario feature detection of the current image frame, obtain the acting force which affects the movement of the hair comprise instructions to:
in response to at least one of detecting that a head position-posture of a user in the current image frame is changed relative to the previous image frame or detecting a presence of an external force applied to the hair in the current image frame, obtain the acting force which affects the movement of the hair.

17. The electronic device of claim 13, wherein the historical particle information comprises: a historical particle speed and a historical particle position;
and wherein the instructions to determine, based on the acting force and the historical particle information, the current particle positions of the hair particle in the current image frame comprise instructions to:
for a hair particle, determine, based on the historical particle speed and the acting force, a current particle speed of the hair particle in the current image frame; and
determine, based on the current particle speed and the historical particle position, a current particle position of the hair particle in the current image frame.

18. The electronic device of claim 17, wherein the instructions to determine, based on the historical particle speed and the acting force, the current particle speed of the hair particle in the current image frame comprise instructions to:
determine, based on the acting force and a mass matrix of the hair particle, a current particle acceleration of the hair particle in the current image frame; and
determine the current particle speed of the hair particle based on the historical particle speed, the current particle acceleration and a frame time interval between the previous image frame and the current image frame;
and wherein the instructions to determine, based on the current particle speed and the historical particle position, the current particle position of the hair particle comprise instructions to:
determine the current particle position of the hair particle based on the historical particle position, the mass matrix of the hair particle, the current particle speed and the frame time interval.

19. The electronic device of claim 13, wherein after the instructions to determine the current particle position of the hair particle in the current image frame, the instructions further comprise instructions to:
detect, based on a current head position of a user's head in the current image frame, and the current particle position of the hair particle, whether there is a collision particle located in the user's head among the plurality of hair particles of the hair;
in response to detecting a presence of the collision particle, project the collision particle onto a surface of the user's head, so as to obtain a corresponding projection position; and
use the projection position as the current particle position of the collision particle.

20. The electronic device of claim 13, wherein after the instructions to determine the current particle position of the hair particle in the current image frame, the instructions further comprise instructions to:
obtain a user head model matrix corresponding to the current image frame, and obtain initial particle positions pre-configured for the plurality of hair particles of the hair;
determine, based on the user head model matrix and the initial particle positions, fixed particle positions of the plurality of hair particles of the hair in the current image frame; and
adjust, based on the fixed particle positions, the current particle positions.

21. The electronic device of claim 20, wherein the instructions to adjust, based on the fixed particle positions, the current particle positions comprise instructions to:
obtain, from the fixed particle positions of the plurality of hair particles, a first fixed particle position corresponding to a first hair particle sorted from a hair root position of the hair, and a second fixed particle position corresponding to a second hair particle;
use the first fixed particle position as a current particle position of the first hair particle in the current image frame; and
use the second fixed particle position as a current particle position of the second hair particle in the current image frame.

22. The electronic device of claim 21, wherein the instructions further comprise instructions to:
adjust, based on the first fixed particle position and the second fixed particle position, current particle positions of other hair particles of the hair in the current image frame, such that a distance between adjacent hair particles in the other hair particles after adjusting is equal to a distance between the first fixed particle position and the second fixed particle position.
